(19) United States
(12) Patent Application Publication
(10) Pub. No.: US 2012/0054434 A1
(43) Pub. Date: Mar. 1, 2012

(54) Information Processing Apparatus and Cache Control Method

(76) Inventors: Kazunari Kawamura, Akishima-shi (JP); Takehiko Kurashige, Ome-shi (JP)

(21) Appl. No.: 13/207,155

(22) Filed: Aug. 10, 2011

(30) Foreign Application Priority Data
Aug. 31, 2010 (JP) 2010-194364

(51) Int. Cl. G06F 12/08

(52) U.S. Cl. 711/115; 711/E12.017

(57) ABSTRACT

According to one embodiment, an information processing apparatus which uses a detachable cache device as a cache of a storage device, the apparatus includes a memory, a detachment request detection module, a setting module, and a cache management information module. The memory configured to store cache management information includes information to be used to manage cache data stored in the cache device. The detachment request detection module configured to detect a detachment request of the cache device. The setting module configured to set a non-cache mode to interrupt use of the cache device serving as the cache when the detachment request detection module has detected the detachment request. The cache management information module configured to invalidate information concerning first cache data corresponding to first data in the cache management information when writing the first data to the storage device in the non-cache mode.

### CROSS-REFERENCE TO RELATED APPLICATIONS

This application is based upon and claims the benefit of priority from prior Japanese Patent Application No. 2010-194364, filed Aug. 31, 2010, the entire contents of which are incorporated herein by reference.

### FIELD

Embodiments described herein relate generally to an information processing apparatus which uses a detachable storage device as a cache and a cache control method.

### BACKGROUND

These days, relatively inexpensive detachable high-speed interfaces represented by Universal Serial Bus (USB) 3.0 are becoming popular and usable as a cache device when read- and write-accessing a low-speed hard disk. Additionally, as USB flash drives become cheaper and their capacities increase, the flash drive may partially be used as a user area, like a normal USB flash drive, instead of using the entire flash drive as a cache device.

In this case, a USB flash drive serving as a cache device may be used to transfer user data. In the conventional cache system, however, if the USB flash drive is detached just for a short while, matching of data that has been updated during the detachment is impossible, and all cached data is handled as invalid. Hence, the cache system cannot exhibit its advantages until cache data is accumulated again.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing an example of the system configuration of an information processing apparatus according to an embodiment.

FIG. 2 is an exemplary view for explaining an example of information stored in cache management information.

FIG. 3 is an exemplary flowchart illustrating an example of a processing procedure when detaching a USB flash drive.

FIG. 4 is an exemplary flowchart illustrating an example of a processing procedure when accessing an HDD in a non-cache mode.

FIG. 5 is an exemplary flowchart illustrating an example of a processing procedure when attaching a USB flash drive.

### DETAILED DESCRIPTION

Various embodiments will be described hereinafter with reference to the accompanying drawings.

In general, according to one embodiment, an information processing apparatus which uses a detachable cache device as a cache of a storage device, the apparatus includes a memory, a detachment request detection module, a setting module, and a cache management information module. The memory configured to store cache management information comprising information to be used to manage cache data stored in the cache device. The detachment request detection module configured to detect a detachment request of the cache device. The setting module configured to set a non-cache mode to interrupt use of the cache device serving as the cache when the detachment request detection module has detected the detachment request. The cache management information module configured to invalidate information concerning first cache data corresponding to first data in the cache management information when writing the first data to the storage device in the non-cache mode.

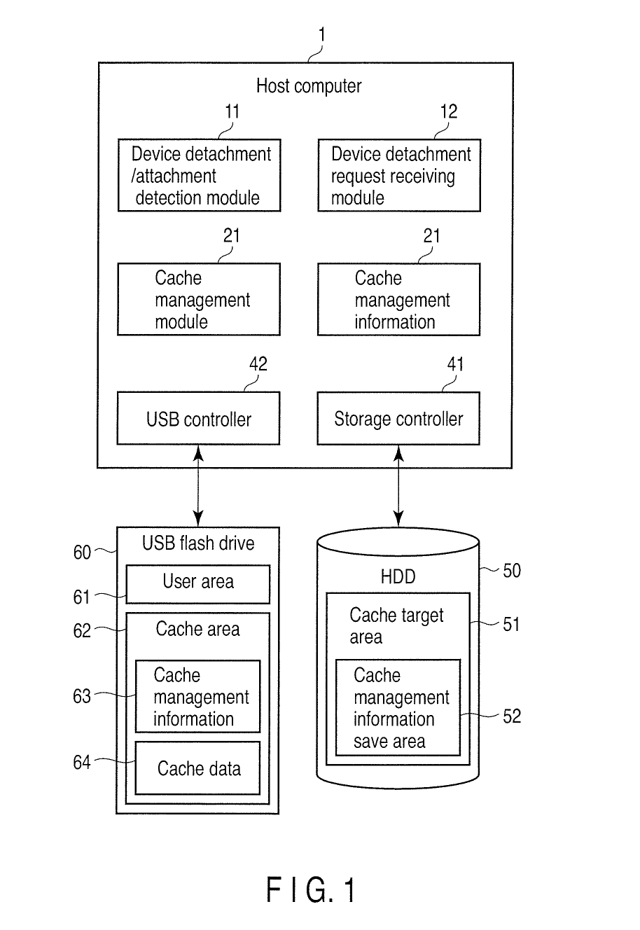

FIG. 1 shows an example of a disk cache system which uses a partial area of a removable storage device (for example, USB flash drive) as a cache device and sets an HDD as a cache target.

A hard disk drive (HDD) 50 that is the cache target and a USB flash drive 60 serving as the cache device are connected to a host computer 1. The USB flash drive 60 is a detachable cache device.

The host computer 1 includes a CPU. The CPU executes an operating system. The host computer 1 also includes a storage controller 41, a USB controller 42, and the like. The storage controller 41 performs data transfer control processing for the hard disk drive 50. The USB controller 42 performs data transfer control processing for the USB flash drive 60.

The computer 1 comprises a device detachment/attachment detection module 11, a device detachment request receiving module 12, a cache management module 21, and cache management information 31.

The device detachment/attachment detection module 11 detects detachment/attachment of the USB flash drive 60 serving as the removable storage device.

The cache management module 21 manages cache data 64 in the USB flash drive 60, cache management information 63 in the USB flash drive 60, and the cache management information 31. The pieces of cache management information 31 and 63 store data necessary for managing the cache data.

A cache target area 51 as the cache target and a cache management information save area 52 exist in the HDD 50. The cache target area 51 stores data created by the user, system data, and the like. The cache management information save area 52 exists in the cache target area 51 in FIG. 1 but may be outside the cache target area 51.

A user area 61 where data created by the user is saved and a cache area 62 where data concerning cache is stored are set in the USB flash drive 60. The cache area 62 stores the cache management information 63 and the cache data 64.

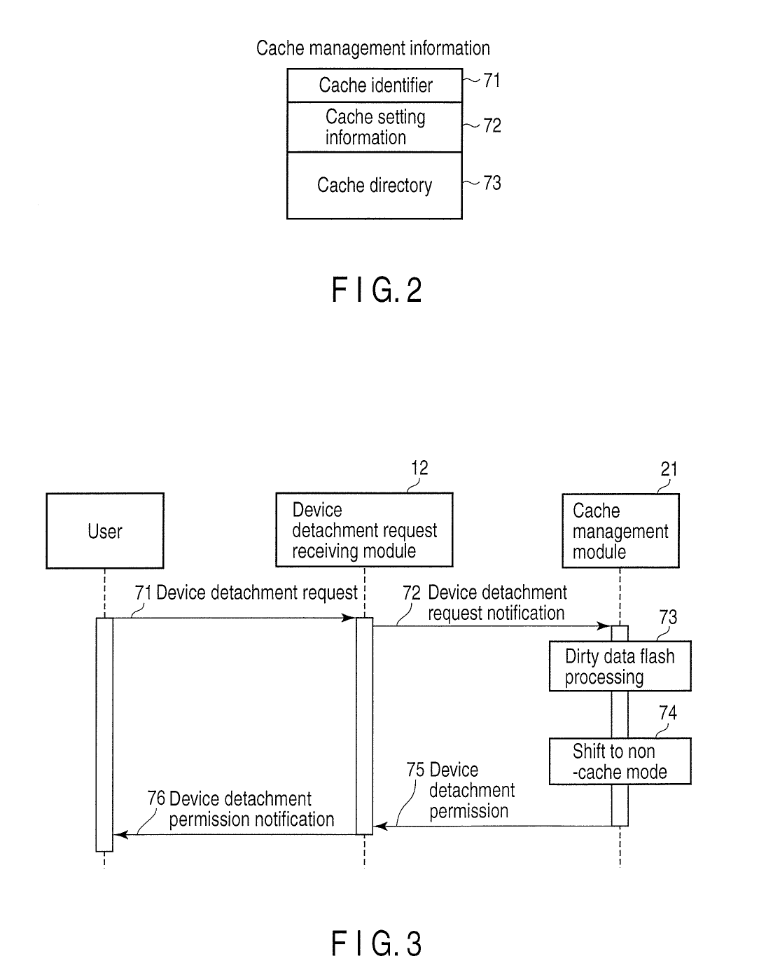

An example of the cache management information 31 of the host computer 1 and the cache management information 63 in the cache area 62 of the USB flash drive 60 will be described next with reference to FIG. 2. A cache identifier 71, cache setting information 72, and a cache directory 73 are described in the cache management information 31 or 63. The cache identifier 71 describes an identifier to be used to identify the USB flash drive 60. The identifier includes a vendor name and a serial number. The cache setting information 72 records the size of the cache management information 31 or 63, the cache data position and capacity on the USB flash drive, a flag representing whether shutdown has been carried out normally, and the like. The cache directory 73 describes association information between the cache target data position and the position in the cache data 64 and dirty information. The dirty information represents whether corresponding data in the cache data 64 has already been written to the HDD 50 or not.

The operation of this arrangement will be described.

If the USB flash drive 60 is attached to the host computer 1 in an activated state, the device detachment/attachment detection module 11 detects the attachment to the cache management module 21. When the device detachment/attachment detection module 11 detects the attachment of the USB flash drive 60, the cache management module 21 sets itself in a cache mode.

When the user performs an operation of detaching the USB flash drive 60, the device detachment request receiving module 12 detects the operation. Upon detecting the operation, the device detachment request receiving module 12 notifies the cache management module 21 of the presence of the detachment request. The cache management module 21 determines whether the USB flash drive 60 is detachable. Upon determining that the USB flash drive may be detached, the device detachment request receiving module 12 notifies the user that USB flash drive may be detached. When the user detaches the USB flash drive 60, the cache management module 21 sets itself in a non-cache mode to directly read- or write-access the HDD based on a read or write request.

Upon receiving a read or write request, the cache management module 21 accesses the HDD 50 or the USB flash drive 60 based on the mode of its own, that is, the cache mode or the non-cache mode, thereby reading or writing data.

Detailed operations in the cache mode and the non-cache mode will be described below.

A data access operation for the HDD 50 in the cache mode with the USB flash drive 60 attached will be explained first. During the operation of the host computer 1, the cache management module 21 receives the read/write request issued for the HDD 50 before the storage controller 41 and appropriately allocates the read/write request to the USB flash drive 60 or the HDD 50.

For example, upon receiving a read request, the cache management module 21 confirms whether cache data corresponding to the requested data is stored in the cache data 64 of the USB flash drive 60. If the cache data is stored in the cache data 64 of the USB flash drive 60, the cache management module 21 issues, to the USB flash drive 60, a command to read the cache data corresponding to the requested data. Then, the cache data read from the USB flash drive 60 is output in response to the read request.

If the cache data corresponding to the read request does not exist in the cache data 64 of the USB flash drive 60, the cache management module 21 issues, to the storage controller 41, a command to read the requested data from the HDD 50. The cache management module 21 confirms whether an area to write the data corresponding to the read request can be allocated. If the area to write the data read from the HDD 50 can be allocated in the cache data 64, the cache management module 21 writes, in the area allocated in the USB flash drive 60, the data read from the HDD 50 by the storage controller 41 and outputs it as the read request. If the area to write the cache data cannot be allocated in the cache data 64, the cache management module 21 only outputs the read request without saving the read data as cache data.

When a write request is received, and an area to write data corresponding to the write request can be allocated or has already been allocated in the cache data 64 of the USB flash drive 60, the cache management module 21 issues, to the USB flash drive 60, a command to write the write-requested data in the cache data 64 of the USB flash drive 60. The write-requested data is written to the cache data 64 as cache data. After that, the data is read from the cache data 64 and written to the HDD 50.

If the area to write the data corresponding to the write request cannot be allocated in the cache data 64 of the USB flash drive 60, the cache management module 21 issues, to the HDD 50, a command to directly write the requested data. The data written only to the USB flash drive 60 is recorded in the cache directory 73 of the cache data 64 in the cache area 62 as dirty data.

Note that in the cache mode, when the host computer 1 shuts down, the cache management information 31 is lost. Hence, when shutting down the host computer 1 with the USB flash drive 60, the cache management module 21 copies the cache management information 31 and saves it in the cache management information 63 of the USB flash drive 60 and the cache management information save area 52 of the HDD 50.

When the host computer 1 with the USB flash drive 60 is activated, the cache management module 21 loads the cache management information 63 of the USB flash drive 60 to the host computer 1 as the cache management information 31. When the host computer 1 without the USB flash drive 60 is activated, the cache management module 21 loads cache management information saved in the cache management information save area 52 of the HDD 50 to the host computer 1 as the cache management information 31. During the operation, only the cache management information 31 in the host computer 1 is updated.

Processing when detaching the USB flash drive 60 serving as the cache device in the cache mode will be described next with reference to FIG. 3. With this operation, the cache mode changes to the non-cache mode.

FIG. 3 illustrates an example of a procedure when detaching the USB flash drive 60 (device). When the user performs an operation for device detachment, the device detachment request receiving module 12 receives the cache device detachment request from the user (block 71). The device detachment request receiving module 12 transmits the detachment request to the cache management module 21 (block 72). The cache management module 21 performs flash processing of dirty data stored only in the USB flash drive 60 (block 73). The dirty data flash processing is processing of writing, to the HDD 50, data stored as cache data only in the USB flash drive 60. Note that the dirty data flash processing is performed under a specific condition such as shutdown of the operating system. After that, the cache management module 21 sets itself in the non-cache mode (block 74). When the shift to the non-cache mode is completed, the cache management module 21 returns a detachment enable notification to the device detachment request receiving module 12 (block 75). Upon receiving the detachment enable notification, the device detachment request receiving module 12 notifies the user that detachment is possible by display on the screen or the like (block 76).

When set in the non-cache mode, the cache management module 21 issues, to the HDD 50 that is the cache target, all read/write requests issued to the cache target by the operating system. However, for a write request, the cache management module 21 refers to the cache management information 31 and, if data corresponding to the write request exists in the detached cache device, updates the cache management information 31 to invalidate the data in the cache device.

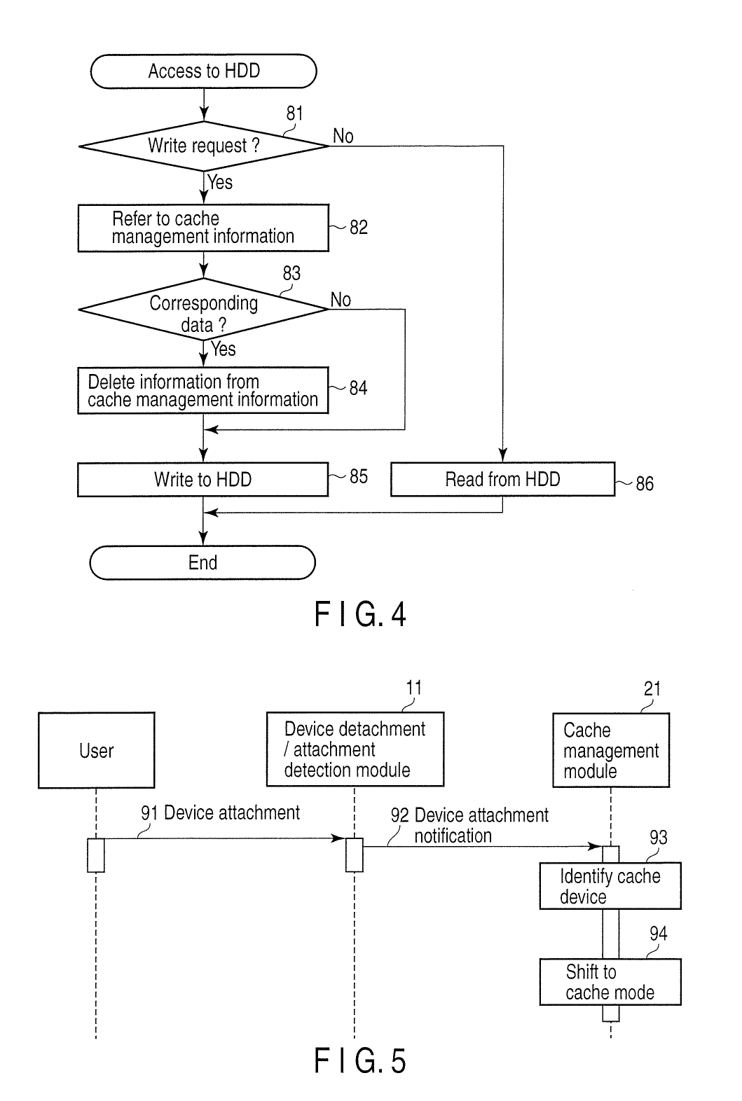

A processing procedure to be executed by the cache management module 21 upon receiving a read/write request in the non-cache mode with the USB flash drive 60 will be described next with reference to FIG. 4.

Upon access to the HDD 50, the cache management module 21 determines whether the access is a write request (block 81). If the access is not a write request, that is, the access is a read request (NO in block 81), the cache management module 21 reads the requested data from the HDD 50 (block 86).

If the access is a write request (YES in block 81), the cache management module 21 refers to the cache management information 31 (block 82). The cache management module 21 determines whether information concerning cache data corresponding to the write-requested data exists in the cache management information 31 (block 83).

If corresponding information exists (YES in block 83), the cache management module 21 invalidates the information concerning cache data corresponding to the write-requested data in the cache management information 31 (block 84). If the corresponding information does not exist (NO in block 83), or after the processing in block 84, the cache management module 21 writes the requested data to the HDD 50 (block 85).

When a data write request for the HDD 50 is issued, information concerning cache data corresponding to the requested data is invalidated in the cache management information 31. Information concerning cache data corresponding to data that has changed in the non-cache mode is deleted. For this reason, when accessing the changed data, the operating system does not access the cache data in the USB flash drive 60 that has been attached again. This allows to effectively use the cache data in the USB flash drive 60 attached again.

Note that when shutting down the host computer 1 without the USB flash drive 60 serving as the cache device in the non-cache mode, the cache management module 21 saves the cache management information 31 in the cache management information save area 52 of the HDD 50.

Hence, when the host computer 1 is shut down in the non-cache mode and then activated after attachment of the USB flash drive 60, the cache management information exists in the cache management information save area 52. For this reason, not the cache management information in the USB flash drive 60 serving as the cache device but the management information saved in the cache management information save area 52 of the HDD 50 is used. When the cache management information in the HDD 50 is loaded into the cache management information save area 52, the cache management information in the cache management information save area 52 of the HDD 50 is deleted. This allows to prevent the information from being erroneously used.

A processing procedure when the USB flash drive 60 serving as the cache device is attached in the non-cache mode will be described next with reference to the flowchart of FIG. 5. With this operation, the non-cache mode changes to the cache mode.

When the user attaches the USB flash drive 60 serving as the cache device after the host computer 1 has been activated (block 91), the device detachment/attachment detection module 11 detects the USB flash drive 60. The device detachment/attachment detection module 11 notifies the cache management module 21 of attachment of the USB flash drive 60 (block 92). The cache management module 21 reads the cache management information 31 and collates the cache identifier 71 and the cache setting information 72, thereby confirming that the cache device is correct (block 93). Upon confirming that the cache device is correct, the cache management module 21 sets itself in the cache mode (block 94). The cache management module 21 performs the cache operation based on the updated cache management information 31 in the host computer 1.

Upon receiving the cache device detachment request in the cache mode, the cache management module 21 may record an alteration detection means such as an error correction code (ECC) in the cache data of the USB flash drive 60 to improve the security.

In the non-cache mode, the cache management module 21 may measure the amount of valid cache data, and when the amount of valid cache data has fallen below a predetermined amount, stop cache management to reduce the overhead of read/write processing.

In the non-cache mode, the cache management module 21 may measure the amount of valid cache data, and if valid data in a predetermined amount or more does not exist at the time of cache device attachment, invalidate all cache data.

Note that in the above-described example, a USB flash drive is used as an example of a detachable cache device. However, not only the USB flash drive but also a memory card such as an SD card is usable as the cache device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus which uses a detachable cache device as a cache of a storage device, the apparatus comprising:
a memory configured to store cache management information comprising information to be used to manage cache data stored in the cache device;
a detachment request detection module configured to detect a detachment request of the cache device;
a setting module configured to set a non-cache mode to interrupt use of the cache device serving as the cache when the detachment request detection module has detected the detachment request; and
a cache management information module configured to invalidate information concerning first cache data corresponding to first data in the cache management information when writing the first data to the storage device in the non-cache mode.

2. The apparatus of claim 1, the cache management information comprising information representing second cache data that is stored in the cache device but not in the storage device, and
the apparatus further comprises a write module configured to write the second cache data to the storage device based on the cache management information when the detachment request detection module has detected the detachment request.

3. The apparatus of claim 2, wherein the setting module is configured to set the non-cache mode after the write module has written the second cache data to the storage device.

4. The apparatus of claim 1, further comprising storage module configured to store the cache management information in the storage device when the information processing is shut down apparatus without the cache device.

5. The apparatus of claim 1, further comprising attachment detection module configured to detect attachment of the cache device, and
wherein the setting module is configured to set a cache mode to resume use of the cache device serving as the cache when the attachment detection module has detected the attachment of the cache device.

6. A cache control method which uses a detachable cache device as a storage destination of cache data of a storage device, comprising:
managing cache management information comprising information to be used to manage cache data stored in the cache device;
setting a non-cache mode to interrupt use of the cache device serving as a cache upon detecting a detachment request to detach the cache device; and
invalidating information concerning first cache data corresponding to first data in the cache management information when writing the first data to the storage device in the non-cache mode.
